(19) United States
(12) Patent Application Publication
(10) Pub. No.: US 2025/0185106 A1
(43) Pub. Date: Jun. 5, 2025

(54) HANDLING OF DATA TRANSMISSION IN DOWNLINK (DL) SMALL DATA TRANSMISSION (SDT)

(71) Applicant: Lenovo (Beijing) Limited, Beijing (CN)

(72) Inventors: Ran Yue, Beijing (CN); Lianhai Wu, Beijing (CN); Mingzeng Dai, Shanghai (CN); Min Xu, Beijing (CN); Jie Hu, Beijing (CN)

(73) Assignee: Lenovo (Beijing) Limited, Beijing (CN)

(21) Appl. No.: 18/725,678

(22) PCT Filed: Dec. 30, 2021
(86) PCT No.: PCT/CN2021/143059

§ 371 Date: Jun. 28, 2024

(51) Int. Cl. H04W 76/27

(52) U.S. Cl. CPC H04W 76/27

(57) ABSTRACT

Methods and apparatuses for handling of data transmission in DL small data transmission (SDT) are disclosed. A network device comprises a processor, and a transceiver coupled to the processor, wherein the processor is configured to: transmit, via the transceiver, DL data during DL SDT to a terminal device that supports an Radio Resource Control (RRC) non-CONNECTED state; determine that the connection with the terminal device is lost before the DL SDT successfully completes; and transmit, via the transceiver, an indication to the terminal device or other network device(s) or a core network device, for completing the DL SDT.

### FIELD

The subject matter disclosed herein generally relates to wireless communications, and more particularly relates to methods and apparatuses for handling of data transmission in DL small data transmission (SDT).

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), small data transmission (SDT), configured grant (CG), CG based SDT (CG-SDT), random access channel (RACH), RACH based SDT (RA-SDT), Reference Signal Received Power (RSRP), Mobile originate (MO), Mobile terminated (MT), radio access network (RAN), 5G core (5GC), physical random access channel (PRACH), time alignment or timing advance or timing adjustment (TA), TA timer (TAT), timing advance group (TAG), primary TAG (PTAG), secondary TAG (STAG), Transmit-Receive Point (TRP), Physical Uplink Control Channel (PUCCH), Physical Uplink Shared Channel (PUSCH), time division multiplexing (TDM), control resource set (CORESET), reference signal (RS), inter-cell beam management (ICBM), Multiple-Input Multiple-Output (MIMO), Data Resource Bearer (DRB), Signal Resource bearer (SRB), Radio Network Temporary Identifier (RNTI), Inactive RNTI (I-RNTI), Physical Downlink Control Channel (PDCCH), RAN-based Notification Area (RNA), Paging Control Channel (PCCH), Reference Signal Received Power (RSRP), Information Element (IE), media access control (MAC), Radio Link Control (RLC), Access Network (AN), core network (CN), radio link failure (RLF), NR unlicensed spectrum (NR-U).

There are two RRC states for 4G LTE: RRC_IDLE and RRC_CONNECTED. 5G NR introduces a new RRC state, RRC_INACTIVE. Therefore, in 5G NR, RRC has three distinct states: RRC_IDLE, RRC_CONNECTED and RRC_INACTIVE.

RRC_IDLE: Upon power on, UE enters into RRC_IDLE state. UE may move to this state from either RRC_CONNECTED state or RRC_INACTIVE state.

RRC_INACTIVE: UE moves to this state from RRC_CONNECTED state. It is connected but inactive state of UE. In this state, UE maintains RRC connection and at the same time minimizes signaling and power consumption.

RRC_CONNECTED: UE remains in connection with the 5G-RAN and 5GC in this state.

RRC states transition process is shown in FIG. 1.

The main principle of the RRC_INACTIVE state is that the UE is able to return to the RRC_CONNECTED state as quickly and efficiently as possible. When the UE transforms to RRC_INACTIVE state, both the UE and the RAN store all the information necessary to quickly resume to RRC_CONNECTED state.

An UE in RRC_INACTIVE state may initiate a resume procedure when there is a need to transmit data or signaling. In this case, the UE transmits an RRC resume request that includes the UE identifier and a security token to verify the legitimacy of the resume request. After the UE configuration is successfully retrieved, the target node (e.g. the base station that receive the RRC resume request) resumes the stored configuration at the UE and applies any necessary modifications, such as the configuration of measurements and the addition or removal of bearers. The respective RRC resume message is integrity protected and encrypted using the security context stored in the network and the UE.

In the RRC_INACTIVE state, the UE is in a power-saving sleep state, but it still retains part of the RAN context (security context, UE capability information, etc.), and can be quickly awakened by a message to transfer from the RRC_INACTIVE state to the RRC_CONNECTED state. NR Release 17 supports direct transmission of small data transmission (SDT) in the RRC_INACTIVE state.

A current SDT procedure is described as follows.

A SDT configuration (e.g. CG based SDT (CG-SDT) configuration) has been configured to the UE when the UE is released to RRC_INACTIVE state. Several CG occasions for SDT (e.g. CG resources) are configured in the CG-SDT configuration. Alternatively, several CG configurations for SDT are configured. When SDT data arrives, the UE initiates the selection between SDT and non-SDT, also between CG-SDT procedure and RACH based SDT (RA-SDT) procedure if SDT is selected. In particular, if CG-SDT criteria are met, UE selects CG-SDT and initiate SDT procedure; else if RA-SDT criteria are met: UE selects RA-SDT and initiate SDT procedure; else, UE initiates non-SDT procedure. CG-SDT criteria are considered met, if 1) available data volume <=data volume threshold and 2) RSRP is greater than or equal to a configured threshold. RA-SDT criteria is considered met, if 1) available data volume <=data volume threshold; 2) RSRP is greater than or equal to a configured threshold; and 3) 4 step RA-SDT resources are configured on the selected UL carrier and criteria to select 4 step RA-SDT is met; or 2 step RA-SDT resources are configured on the selected UL carrier and criteria to select 2 step RA-SDT is met.

A 4 step RACH procedure (that can be used as RA-SDT) comprises: UE transmits a preamble (Msg1) on PRACH to a network device (e.g. gNB)); the network device transmits a response (Msg2) to the preamble); the UE transmits uplink information (Msg3) according to the response; and the network device transmits a contention resolution message (Msg4) according to the uplink information. A 2-step RACH procedure (that can be used as RA-SDT) comprises the transmission of MsgA and MsgB, wherein MsgA corresponds to a combination of Msg1 and Msg3 and MsgB corresponds to a combination of Msg2 and Msg4. It can be seen that RA-SDT (4-step RA-SDT or 2-step RA-SDT) allows SDT to use an uplink grant received via a random access procedure for SDT.

On the other hand, CG-SDT allows SDT to use a configured grant without performing a random access procedure.

The above-described SDT (e.g. RA-SDT and CG-SDT) can be referred to as UL (uplink) SDT. In addition, the above-described SDT is initiated by the UE, which can be referred to as MO (Mobile originate) SDT.

In the MO SDT initiated by the UE, a network device (e.g. gNB) can also transmit DL data (e.g. small data). Such DL small data transmission can be referred to as DL SDT. In addition, SDT can be initiated by the network device (e.g. gNB). The SDT that is initiated by the gNB is referred to as MT (Mobile terminated) SDT. An MT SDT procedure is initiated by the network device (e.g. gNB) for a downlink (DL) data transmission. As a whole, DL SDT means an MT SDT (initiated by gNB) or an MO SDT (initiated by UE) in which DL data can be transmitted or the DL data transmission in MO SDT or the DL data transmission in MT SDT while the UE remains in RRC_INACTIVE state without transiting to RRC_CONNECTED state.

There is a potential scenario that the UE reselects a neighboring cell while the DL data transmission by DL SDT has not successfully completed. The behaviors of the gNB and the UE in the scenario have not been discussed.

This invention targets the behaviors of the gNB and the UE, if the UE reselects a neighboring cell while the DL data transmission by the DL SDT has not successfully completed.

### BRIEF SUMMARY

Methods and apparatuses for handling of data transmission in DL SDT are disclosed.

In one embodiment, a network device comprises a processor; and a transceiver coupled to the processor, wherein the processor is configured to: transmit, via the transceiver, DL data during DL small data transmission (SDT) to a terminal device that supports an Radio Resource Control (RRC) non-CONNECTED state; determine that the connection with the terminal device is lost before the DL SDT successfully completes; and transmit, via the transceiver, an indication to the terminal device or other network device(s) or a core network device, for completing the DL SDT.

In one embodiment, the connection with the terminal device being lost is determined by one of: the buffer corresponding to the SDT data is not empty; the RRC message to complete the DL SDT has not been transmitted; after predetermined times of failure of DL and/or UL transmissions during the DL SDT within the serving cell; after predetermined times of failure of DL and/or UL transmissions during the DL SDT within the serving cell if the RSRP of the terminal device is less than a threshold; and expiration of a timer that starts or restarts upon the DL data transmission.

In some embodiment, the indication to the terminal device is one of: an indication of a DL SDT or of a legacy DL data transmission on Uu interface for continuing previously transmitted DL SDT in which the DL transmission has not successfully completed; and a paging message or a legacy paging message for continuing previously transmitted DL SDT in which the DL transmission has not successfully completed. In this condition, the processor is further configured to determine that the terminal device is in a trigger condition for autonomously triggering the paging message or legacy paging message. In some embodiment, the indication to the other network device(s) is at least one of: a RAN paging message for continuing previously transmitted DL SDT in which the DL transmission has not successfully completed; and an indication to the other network device(s) to initiate an MT SDT or a legacy data transmission to continue previously transmitted DL SDT in which the DL transmission has not successfully completed. In some embodiment, the indication to the core network device is at least one of: an indication that the DL data transmission in the DL SDT has not successfully completed; and an initiation of an AN release procedure to trigger a CN paging.

In some embodiment, the terminal device is identified by its stored RNTI or an identity allocated by upper layers. In some embodiment, the network device does not have the context of the terminal device, and the method further comprises transmitting the indication to another network device that has the context of the terminal device.

In one embodiment, a terminal device that supports an RRC non-CONNECTED state with a network device comprises a processor; and a transceiver coupled to the processor, wherein the processor is configured to: receive, via the transceiver, DL data during DL SDT from the network device; reselect a neighboring cell when the DL SDT to the terminal device has not successfully completed; and trigger a RACH in the reselected neighboring cell. In some embodiment, the DL SDT is a Mobile Terminating (MT) SDT initiated by the network device. In some embodiment, the terminal device further comprise a memory coupled to the processor, wherein, the processor is further configured to store an identity in the memory, and wherein, the stored identity is indicated in the RACH.

In another embodiment, a method performed by a terminal device that supports an RRC non-CONNECTED state with a network device comprises receiving DL data transmission during DL SDT from the network device; reselecting a neighboring cell when the DL DL SDT to the terminal device has not successfully completed; and triggering a RACH in the reselected neighboring cell.

In yet another embodiment, a method may be performed by a network device comprises transmitting DL data during DL SDT to a terminal device that supports an RRC non-CONNECTED state; determining that the connection with the terminal device is lost before the DL SDT successfully completes; and transmitting an indication to the terminal device or other network device(s) or a core network device, for completing the DL SDT.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates RRC states in NR;

FIG. 2 illustrates a scenario of UE reselecting a neighboring cell (or neighboring gNB);

FIG. 3 illustrates another scenario of UE reselecting a neighboring cell (or neighboring gNB);

FIG. 4 is a schematic flow chart diagram illustrating an embodiment of a method;

FIG. 5 is a schematic flow chart diagram illustrating a further embodiment of a method; and

FIG. 6 is a schematic block diagram illustrating apparatuses according to one embodiment.

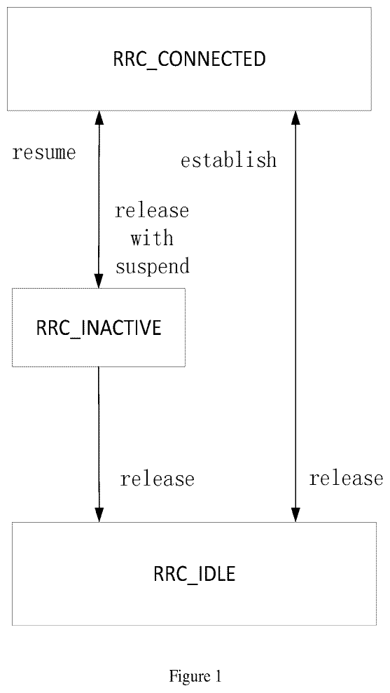

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

SDT (small data transmission) can be supported not only in RRC_INACTIVE state but also in RRC_IDLE state. The RRC_INACTIVE state and the RRC_IDLE state can be collectively referred to as RRC non-CONNECTED state. All of the embodiments apply to a terminal device (e.g. UE) in RRC non-CONNECTED state.

In the following description, “paging for MT-SDT” means a message or an indication for the upcoming DL-triggered small data transmission. The name of the expression “paging for MT-SDT” may be replaced with other name(s). However, the meaning of the expression does not change. The paging for MT-SDT received by the UE can be contained in a message. The UE that received the indication is expected to receive the DL small data in RRC_INACTIVE state. The message can be a paging message, a short message, a short messages indicator, or a new broadcast message or a new RRC message or a new message on Uu interface.

Further, in the following description, “Xn interface” (e.g. “X2 interface”) means any interface between network nodes. Further, the network nodes (NW nodes) are assumed to manage one or more cells that are within an RNA configured to the UE. The RNA can cover a single or multiple cells, and shall be contained within the CN registration area. Xn connectivity should be available within the RNA. A network node is for example a base station (e.g. gNB).

The base station (e.g. gNB) (which can also be referred to as BS, network device, network node, etc) may transmit the paging for MT-SDT to the UE when downlink (DL) data arrives at the gNB and the size of the DL data meets certain criteria (e.g. the size of the DL data is smaller than a pre-defined threshold). When the paging for MT-SDT is received by a UE in RRC non-CONNECTED (e.g. RRC_IDLE or RRC_INACTIVE) state, the UE is expected to receive the DL data as SDT without transiting to RRC_CONNECTED state.

On the other hand, when downlink (DL) data arrives at the gNB, if there is an ongoing MO SDT (e.g. CG-SDT or RA-SDT), the gNB may transmit the DL data by the MO SDT.

Hereinafter, DL SDT means an MT SDT (initiated by gNB) or an MO SDT (initiated by UE) in which DL data can be transmitted or the DL data transmission in MO SDT or the DL data transmission in MT SDT while the UE remains in RRC non-CONNECTED state without transiting to RRC_CONNECTED state. In other words, DL data transmission in DL SDT can also be described as DL data transmission in SDT.

It is expected that the DL data transmission completes successfully in DL SDT procedure. However, it may happen that, before the DL data transmission in DL SDT completes, the UE reselects a neighboring cell. This disclosure proposes gNB's behaviors and UE's behaviors if the UE reselects a neighboring cell before the ongoing DL data transmission in DL SDT completes.

It is clear from UE's perspective that the UE reselects the neighboring cell before the ongoing DL data transmission in DL SDT completes. However, from gNB's perspective, the gNB can only determine that a connection to the UE is lost during the ongoing DL data transmission in DL SDT, which may be caused by UE's reselecting the neighboring cell. However, if the gNB loses connection with the UE, it may be caused not only by (1) UE reselects the neighboring cell but also by (2) the UE is blocked because of the bad channel condition of the serving cell. Accordingly, different behaviors (i.e. different solutions, e.g. gNB based solutions and UE based solutions) are proposed for the case that the UE reselects a neighboring cell before ongoing DL data transmission in DL SDT completes.

In the following description, it is assumed that the neighboring cell and the (last) serving cell belong to different base stations (e.g. different gNBs). Accordingly, the serving cell can be represented by serving gNB, while the neighboring cell can be represented by neighboring gNB.

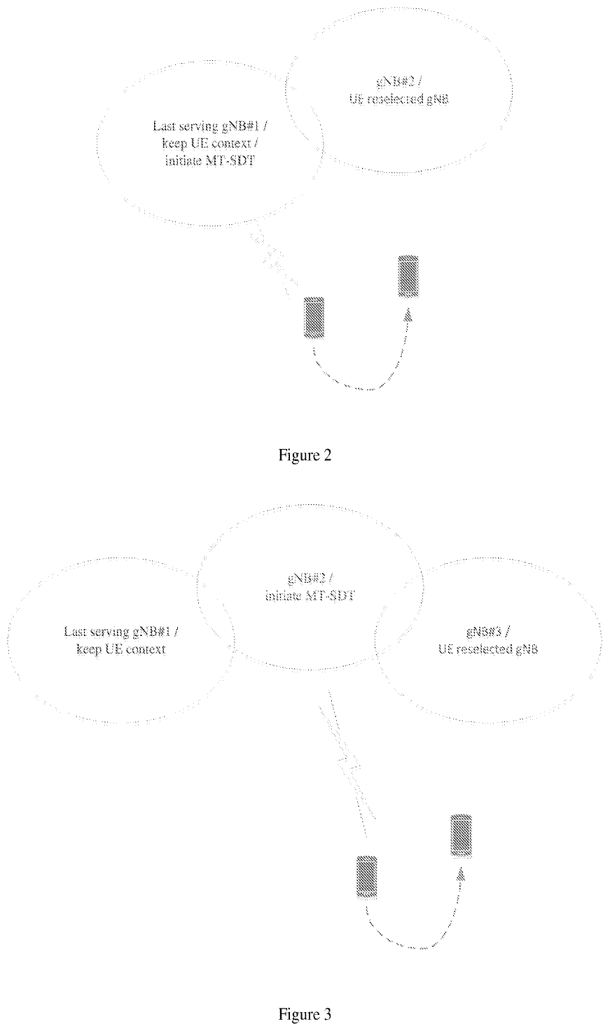

For example, as shown in FIG. 2, the last serving gNB is gNB #1 (i.e. the last serving cell belongs to gNB #1). gNB #1 initiates MT SDT (e.g. by transmitting paging for MT-SDT), and gNB #1 keeps UE context of the UE for which the MT SDT is initiated. Alternatively, gNB #1 transmits DL data in MO SDT initiated by the UE. During the DL SDT (gNB #1 initiated ML SDT or UE initiated MO SDT) procedure, before the DL data transmission successfully completes), the UE reselects a neighboring gNB (e.g. gNB #2) (i.e. the neighboring cell belongs to gNB #2).

A first embodiment relates to the gNB's behaviors after the reselection of the neighboring cell (i.e. neighboring gNB) by the UE.

A DL-triggered SDT (e.g. MT SDT) is initiated or transmitted by the network node #1 (e.g. gNB #1) or the DL data during UL-triggered SDT (e.g. MO SDT) is transmitted by the network node #1 (e.g. gNB #1) to a UE that is in RRC non-CONNECTED state and configured with SDT (e.g. the UE is configured with SDT DRBs and/or SDT SRBs and/or resources for SDT). Alternatively, an MO SDT is initiated by the UE. DL data transmission is performed in SDT (e.g. the MT SDT initiated by the gNB, or the DL data during the MO SDT initiated by the UE).

The gNB (i.e. gNB #1) determines that the DL data transmission in the DL SDT has not successfully completed. The determination can be made according to at least one of the following criteria:
(1) The RRC message (e.g. RRC Release, RRC Resume, etc.) has not been transmitted to terminate or complete the DL SDT.
(2) After N times of failure of DL and/or UL transmissions during DL SDT within the same cell (e.g. the serving cell). Note that the failure is not because of LBT (listen before talk) failure. N can be counted in MAC layer or RLC layer. N is a number that can be pre-defined or configured or up to gNB's implementation or a default value specified in the NR specification. In order to support NR-U, N can be configured or pre-defined or implemented with a larger number compared with NR-U not being supported.
(3) After M times of failure of DL and/or UL transmissions during DL SDT within the same cell (e.g. the serving cell) if the RSRP of the UE is less than a threshold. Note that the failure is not because of LBT (listen before talk) failure. The RSRP of the UE may be notified by the UE in previous transmission(s) in DL SDT. M can be counted in MAC layer or RLC layer. M is a number that can be pre-defined or configured or up to gNB's implementation or a default value specified in the NR specification. The threshold may be also pre-defined or configured or up to gNB's implementation or a default value specified in the NR specification. In order to support NR-U, M can be configured or pre-defined or implemented with a larger number compared with NR-U not being supported.
(4) Expiration of a timer, where the timer starts or restarts upon the DL data are transmitted in DL SDT.
(5) The buffer corresponding to the SDT data is not empty.

When the gNB (e.g. gNB #1) determines that the DL data transmission in DL SDT has not successfully completed, the gNB may try to perform at least one of the following operations: (1) trying to find the UE by itself by transmitting an indication to the UE (according to a first sub-embodiment); (2) trying to communicate with other gNB(s) to find the UE by transmitting an indication to other gNB(s) (according to a second sub-embodiment); and (3) indicates to the core network that the DL transmission has not successfully completed, by transmitting an indication to a core network device.

In all of the following description of the first embodiment (for the first sub-embodiment, the second sub-embodiment, and the third sub-embodiment), the gNB refers to for example gNB #1 in FIG. 2, while gNB #2 can be one of other gNBs or gNBs that manage the cell(s) within the RNA configured to the UE.

According to the first sub-embodiment, the gNB tries to find the UE by itself.

Implementation 1-1: the gNB autonomously triggers (or initiates) an indication of a DL SDT for continuing previously transmitted DL SDT in which the DL transmission has not successfully completed. Alternatively, the gNB autonomously triggers (or initiates) an indication of a legacy DL data transmission on Uu interface (e.g. a legacy DL data transmission for continuing previously transmitted DL SDT in which the DL transmission has not successfully completed). The indication can be included in the paging for MT-SDT or a legacy paging message or a new message on the Uu interface.

Implementation 1-2: the gNB autonomously triggers a paging message (e.g. a paging message for continuing previously transmitted DL SDT in which the DL transmission has not successfully completed). Alternatively, the gNB autonomously triggers a legacy paging message (e.g. a legacy paging message for continuing previously transmitted DL SDT in which the DL transmission has not successfully completed).

Implementation 1-3: the gNB determines that the UE is in a special state, where the special state can be a trigger condition for the gNB to perform Implementation 1-1 or Implementation 1-2.

According to the first sub-embodiment, the gNB may perform one of:
Implementation 1-1;
Implementation 1-2;
Implementation 1-3;
Implementations 1-1 and 1-3; and
Implementations 1-2 and 1-3.

According to the second sub-embodiment, the gNB tries to communicate with other gNB(s) to find the UE.

Implementation 2-1: the gNB autonomously triggers a RAN paging message (e.g. a RAN paging message for continuing previously transmitted DL SDT in which the DL transmission has not successfully completed) to other gNBs that manage the cell(s) within the RNA configured to the UE. Alternatively, the gNB autonomously trigger a legacy RAN paging message (e.g. a legacy RAN paging message for continuing previously transmitted DL SDT in which the DL transmission has not successfully completed) to other gNBs within the RNA configured to the UE. A RAN paging procedure is triggered by the NG-RAN node₁ (e.g. gNB #1) by sending the RAN paging message to the NG-RAN node₂ (e.g. gNB #2), e.g. to request paging of a UE in the NG-RAN node₂ (e.g. gNB #2).

Implementation 2-2: the gNB transmits an indication to the other gNBs (e.g. gNB #2) to initiate an MT SDT or a legacy data transmission to continue previously transmitted DL SDT in which the DL transmission has not successfully completed. The indication can be included in the RAN paging message for MT SDT or a legacy RAN paging or a new message on the Xn interface.

According to the second sub-embodiment, the gNB may performs one of:
Implementation 2-1;
Implementation 2-2; and
Implementations 2-1 and 2-2.

According to the third sub-embodiment, the gNB indicates to the core network that the DL data transmission in previously transmitted DL SDT has not successfully completed.

Implementation 3-1: the gNB indicates to the AMF that the DL data transmission in previously transmitted DL SDT has not successfully completed.

Implementation 3-2: the gNB initiates an AN Release procedure in order to trigger a CN paging.

According to the third sub-embodiment, the gNB may perform one of:
Implementation 3-1;
Implementation 3-2; and
Implementations 3-1 and 3-2.

A fourth sub-embodiment relates to identifying the UE in the first embodiment (e.g. in any of the first, the second and the third sub-embodiments).

One or more of the following identifications can be used:
(1) the stored RNTI by the UE, which can be the RNTI used in non-CONNECTED state or in SDT (e.g. I-RNTI used in RRC_INACTIVE state).
(2) the UE identity allocated by upper layers. The UE identity allocated by upper layers can be used for the paging for MT-SDT.

A second embodiment relates to the UE's behaviors after reselection of the neighboring cell (i.e. neighboring gNB) by the UE.

A DL-triggered SDT (e.g. MT SDT) is initiated or transmitted by the network node #1 (e.g. gNB #1) or the DL data during a UL-triggered SDT (e.g. MO SDT) is transmitted by the network node #1 (e.g. gNB #1) to a UE that is in RRC non-CONNECTED state and configured with SDT (e.g. the UE is configured with SDT DRBs and/or SDT SRBs and/or resources for SDT). Alternatively, an MO SDT is initiated by the UE. DL data transmission is performed in SDT (e.g. the MT SDT initiated by the gNB, or the DL data during the MO SDT initiated by the UE).

Before the DL data transmission in the DL SDT successfully completes (e.g. the RRC message, e.g. RRC release with suspend or RRC resume, is not received) in gNB #1, the UE reselects a neighboring cell (e.g. a neighboring gNB #2).

In an optional step, the UE stores the RNTI used in non-CONNECTED state or in SDT (e.g. I-RNTI used in RRC_INACTIVE state).

After reselecting the neighboring cell, the UE initiates a RACH in the reselected cell. A new cause value for the RACH can be used to indicate that the RACH is initiated for incomplete DL data transmission in previously transmitted DL SDT (e.g. MT SDT initiated by another gNB, or MO SDT previously initiated by the UE).

In the RACH, the UE indicates the UE identity. The UE identity can be the stored RNTI (e.g. the stored I-RNTI when the UE is in RRC_INACTIVE state), or the UE identity allocated by upper layers to the network (e.g. when the UE reselects gNB #2, the UE identity allocated by gNB #2 to the UE).

A variety of the second embodiment relates to the UE's behaviors when radio link problem occurs during DL data transmission in DL SDT.

A DL-triggered SDT (e.g. MT SDT) is initiated or transmitted or a UL-triggered SDT (e.g. MO SDT) is transmitted by the network Node #1 (e.g. gNB #1) to a UE that is in RRC non-CONNECTED state and configured with SDT (e.g. the UE is configured with SDT DRBs and/or SDT SRBs and/or resources for SDT). Alternatively, an MO SDT is initiated by the UE. DL data transmission is performed in DL SDT (e.g. the MT SDT initiated by the gNB, or the MO SDT initiated by the UE).

The UE monitors the radio link quality during the DL SDT. When radio link problem occurs during DL data transmission in DL SDT (i.e. before the DL data transmission in the DL SDT successfully completes), the UE triggers another RRC Resume procedure. The cause value in the RRC Resume Request can indicate the resume request is for the radio link problem during the DL SDT.

The radio link problem occurs means any of the following:
(1) the radio link quality is lower than a threshold.
(2) radio link failure (RLF) for a DL SDT transmission.
(3) DL SDT transmission failures happen (e.g. the HARQ decoding failure within a configured timer, RLC reception failures).

In this manner, a new RACH trigger condition is defined, that is, when radio link problem occurs during DL data transmission in DL SDT, the UE triggers an RRC Resume procedure.

FIG. 3 illustrates another scenario when the UE reselects the neighboring cell before the ongoing DL data transmission in DL SDT completes. As shown in FIG. 3, the last serving gNB (i.e. the last serving cell) is gNB #1. Another gNB (e.g. gNB #2) initiates MT SDT (e.g. under the control of gNB #1). Accordingly, gNB #2 that initiates the MT SDT does not have the UE context (suppose that gNB #1 does not provide the UE context to gNB #2). In other words, the gNB #2 forwards the content received from the serving gNB #1 to the UE during the MT SDT. Alternatively, gNB #2 transmits DL data in MO SDT initiated by the UE. During the DL SDT (e.g. gNB #2 initiated MT SDT or UE initiated MO SDT), before the ongoing DL data transmission successfully completes in the DL SDT, the UE reselects a neighboring gNB (i.e. neighboring cell) (e.g. gNB #3).

A third embodiment relates to the gNB #2's behaviors (as well as gNB #1's behaviors) after the reselection of the neighboring cell (i.e. neighboring gNB #3) by the UE.

gNB #2 fails to retrieve the UE context of the UE (to which the DL SDT is transmitted) (e.g. gNB #2 receives RETRIEVE UE CONTEXT FAILURE message or other message used to reject or partly reject the context retrieve related request). It means that the gNB #2 does not have the full UE context of the UE.

A DL-triggered SDT (e.g. MT SDT) is initiated or transmitted by the network node #2 (e.g. gNB #2) or the DL data during a UL-triggered SDT (e.g. MO SDT) is transmitted by the network node #2 (e.g. gNB #2) to a UE that is in RRC non-CONNECTED state and configured with SDT (e.g. the UE is configured with SDT DRBs and/or SDT SRBs and/or resources for SDT). Alternatively, an MO SDT is initiated by the UE to gNB #2. DL data transmission is performed in SDT (e.g. the MT SDT initiated by the gNB #2, or the MO SDT initiated by the UE).

The gNB #2 determines that the DL data transmission in the DL SDT has not successfully completed. The determination can be made according to at least one of the following criteria:
(1) The RRC message (e.g. RRC Release, RRC Resume, etc.) has not been transmitted to terminate or complete the DL SDT.
(2) After N times of failure of DL and/or UL transmissions during DL SDT within the same cell (e.g. the serving cell). Note that the failure is not because of LBT (listen before talk) failure. N can be counted in MAC layer or RLC layer. N is a number that can be pre-defined or configured or up to gNB's implementation or a default value specified in the NR specification. In order to support NR-U, N can be configured or pre-defined or implemented with a larger number compared with NR-U not being supported.
(3) After M times of failure of DL and/or UL transmissions during DL SDT within the same cell (e.g. the serving cell) if the RSRP of the UE is less than a threshold. Note that the failure is not because of LBT (listen before talk) failure. The RSRP of the UE may be notified by the UE in previous transmission(s) in DL SDT. M can be counted in MAC layer or RLC layer. M is a number that can be pre-defined or configured or up to gNB's implementation or a default value specified in the NR specification. The threshold may be also pre-defined or configured or up to gNB's implementation or a default value specified in the NR specification. In order to support NR-U, M can be configured or pre-defined or implemented with a larger number compared with NR-U not being supported.
(4) Expiration of a timer, where the timer starts or restarts upon the DL data are transmitted in DL SDT.
(5) The buffer corresponding to the SDT data is not empty.

When the gNB (e.g. gNB #2) determines that the DL transmission has not successfully completed, the gNB #2 may try to perform at least one of the following operations: (1) trying to find the UE by itself by transmitting an indication to the UE (according to a first sub-embodiment); (2) trying to communicate with other gNB(s) to find the UE by transmitting an indication to other gNB(s) (according to a second sub-embodiment); (3) indicate to gNB #1 (that has the UE context) that the DL transmission has not successfully completed by transmitting an indication to gNB #1 (according to a third sub-embodiment); and (4) indicates to the core network that the DL transmission has not successfully completed, by transmitting an indication to a core network device (according to a fourth sub-embodiment).

According to the first sub-embodiment of the third embodiment, the gNB #2 tries to find the UE by itself. The gNB #2 may perform one of: Implementation 1-1; Implementation 1-2; Implementation 1-3; Implementations 1-1 and 1-3; and Implementations 1-2 and 1-3, where, Implementation 1-1, Implementation 1-2, and Implementation 1-3 have been described in the first sub-embodiment of the first embodiment.

According to the second sub-embodiment of the third embodiment, the gNB #2 tries to communicate with other gNB(s) to find the UE. The gNB #2 may perform one of: Implementation 2-1; Implementation 2-2; and Implementations 2-1 and 2-2, where, Implementation 2-1 and Implementation 2-2 have been described in the second sub-embodiment of the first embodiment.

According to the third sub-embodiment of the third embodiment, the gNB #2 indicate to gNB #1 (that has the UE context of the UE) that the DL transmission has not successfully completed. The indication is transmitted via Xn interface (e.g. X2 interface). The indication can be an IE of the existing Xn message or an IE of a new Xn message or a new Xn message. After receiving the indication from gNB #2, gNB #1 can choose to perform any of the first sub-embodiment of the first embodiment, the second sub-embodiment of the first embodiment, and the third sub-embodiment of the first embodiment.

According to the fourth sub-embodiment of the third embodiment, the gNB #2 indicates to the core network that the DL transmission in DL SDT has not successfully completed. The gNB #2 may perform one of: Implementation 3-1; Implementation 3-2; and Implementations 3-1 and 3-2, where, Implementation 3-1 and Implementation 3-2 have been described in the third sub-embodiment of the first embodiment.

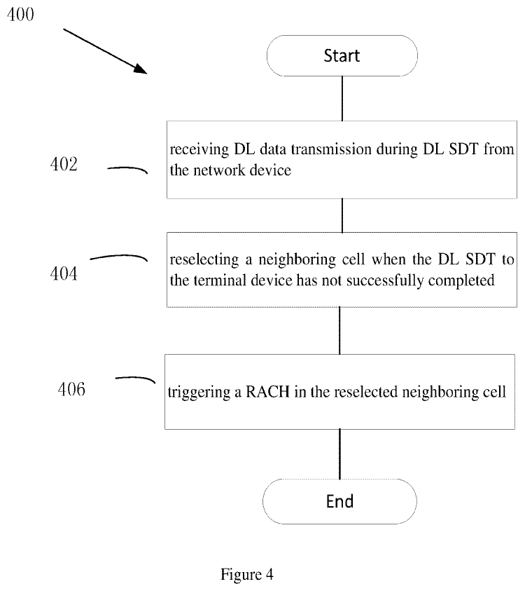

FIG. 4 is a schematic flow chart diagram illustrating an embodiment of a method 400 according to the present application. In some embodiments, the method 400 is performed by an apparatus, such as a remote unit (UE). In certain embodiments, the method 400 may be performed by a processor executing program code, for example, a microcontroller, a microprocessor, a CPU, a GPU, an auxiliary processing unit, a FPGA, or the like.

The method 400 may be performed by a terminal device that supports an Radio Resource Control (RRC) non-CONNECTED state with a network device, and comprise 402 receiving DL data transmission during DL SDT from the network device; 404 reselecting a neighboring cell when the DL SDT to the terminal device has not successfully completed; and 406 triggering a RACH in the reselected neighboring cell.

In one embodiment, the DL SDT is a Mobile Terminating (MT) Small Data Transmission (SDT) initiated by the network device.

In some embodiment, the method may further comprise storing an identity in the memory, and wherein, the stored identity is indicated in the RACH.

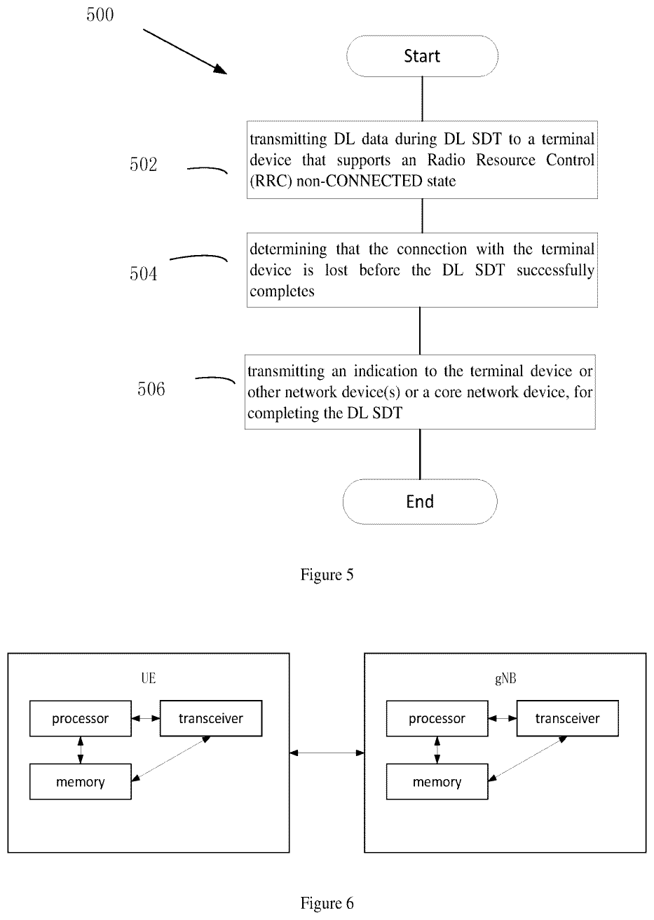

FIG. 5 is a schematic flow chart diagram illustrating a further embodiment of a method 500 according to the present application. In some embodiments, the method 500 is performed by an apparatus, such as a base unit or a network device (e.g. gNB). In certain embodiments, the method 500 may be performed by a processor executing program code, for example, a microcontroller, a microprocessor, a CPU, a GPU, an auxiliary processing unit, a FPGA, or the like.

The method 500 may be performed by a network device and comprise 502 transmitting DL data during DL SDT to a terminal device that supports an Radio Resource Control (RRC) non-CONNECTED state; 504 determining that the connection with the terminal device is lost before the DL SDT successfully completes; and 506 transmitting an indication to the terminal device or other network device(s) or a core network device, for completing the DL SDT.

In one embodiment, the connection with the terminal device being lost is determined by one of: the buffer corresponding to the SDT data is not empty; the RRC message to complete the DL SDT has not been transmitted; after predetermined times of failure of DL and/or UL transmissions during the DL SDT within the serving cell; after predetermined times of failure of DL and/or UL transmissions during the DL SDT within the serving cell if the RSRP of the terminal device is less than a threshold; and expiration of a timer that starts or restarts upon the DL data transmission.

In some embodiment, the indication to the terminal device is one of: an indication of a DL SDT or of a legacy DL data transmission on Uu interface for continuing previously transmitted DL SDT in which the DL transmission has not successfully completed; and a paging message or a legacy paging message for continuing previously transmitted DL SDT in which the DL transmission has not successfully completed. In this condition, the method may further comprise determining that the terminal device is in a trigger condition for autonomously triggering the paging message or legacy paging message.

In some embodiment, the indication to the other network device(s) is at least one of: a RAN paging message for continuing previously transmitted DL SDT in which the DL transmission has not successfully completed; and an indication to the other network device(s) to initiate an MT SDT or a legacy data transmission to continue previously transmitted DL SDT in which the DL transmission has not successfully completed.

In some embodiment, the indication to the core network device is at least one of: an indication that the DL data transmission in the DL SDT has not successfully completed; and an initiation of an AN release procedure to trigger a CN paging.

In some embodiment, the terminal device is identified by its stored RNTI or an identity allocated by upper layers.

In some embodiment, the network device does not have the context of the terminal device, and the method further comprises transmitting the indication to another network device that has the context of the terminal device.

FIG. 6 is a schematic block diagram illustrating apparatuses according to one embodiment.

Referring to FIG. 6, the UE (i.e. remote unit, or terminal device) includes a processor, a memory, and a transceiver. The processor implements a function, a process, and/or a method which are proposed in FIG. 4.

The terminal device that supports an Radio Resource Control (RRC) non-CONNECTED state with a network device comprises a processor, and a transceiver coupled to the processor, wherein the processor is configured to: receive, via the transceiver, DL data during DL SDT from the network device; reselect a neighboring cell when the DL SDT to the terminal device has not successfully completed; and trigger a RACH in the reselected neighboring cell.

In some embodiment, the DL SDT is a Mobile Terminating (MT) SDT initiated by the network device.

In some embodiment, the terminal device further comprise a memory coupled to the processor, wherein, the processor is further configured to store an identity in the memory, and wherein, the stored identity is indicated in the RACH.

Referring to FIG. 6, the gNB (i.e. base unit or network device) includes a processor, a memory, and a transceiver. The processors implement a function, a process, and/or a method which are proposed in FIG. 5.

The network device comprises a processor, and a transceiver coupled to the processor, wherein the processor is configured to: transmit, via the transceiver, DL data during DL small data transmission (SDT) to a terminal device that supports an Radio Resource Control (RRC) non-CONNECTED state; determine that the connection with the terminal device is lost before the DL SDT successfully completes; and transmit, via the transceiver, an indication to the terminal device or other network device(s) or a core network device, for completing the DL SDT.

In one embodiment, the connection with the terminal device being lost is determined by one of: the buffer corresponding to the SDT data is not empty; the RRC message to complete the DL SDT has not been transmitted; after predetermined times of failure of DL and/or UL transmissions during the DL SDT within the serving cell; after predetermined times of failure of DL and/or UL transmissions during the DL SDT within the serving cell if the RSRP of the terminal device is less than a threshold; and expiration of a timer that starts or restarts upon the DL data transmission.

In some embodiment, the indication to the terminal device is one of: an indication of a DL SDT or of a legacy DL data transmission on Uu interface for continuing previously transmitted DL SDT in which the DL transmission has not successfully completed; and a paging message or a legacy paging message for continuing previously transmitted DL SDT in which the DL transmission has not successfully completed. In this condition, the processor is further configured to determine that the terminal device is in a trigger condition for autonomously triggering the paging message or legacy paging message.

In some embodiment, the indication to the other network device(s) is at least one of: a RAN paging message for continuing previously transmitted DL SDT in which the DL transmission has not successfully completed; and an indication to the other network device(s) to initiate an MT SDT or a legacy data transmission to continue previously transmitted DL SDT in which the DL transmission has not successfully completed.

In some embodiment, the indication to the core network device is at least one of: an indication that the DL data transmission in the DL SDT has not successfully completed; and an initiation of an AN release procedure to trigger a CN paging.

In some embodiment, the terminal device is identified by its stored RNTI or an identity allocated by upper layers.

In some embodiment, the network device does not have the context of the terminal device, and the method further comprises transmitting the indication to another network device that has the context of the terminal device.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

What is claimed is:

1. A network device for wireless communication, comprising:
at least one memory; and
at least one processor coupled with the at least one memory and configured to cause the network device to:
transmit downlink (DL) data during DL small data transmission (SDT) to a user equipment (UE) that supports a radio resource control (RRC) non-CONNECTED state;
determine that a connection with the UE is lost before the DL SDT successfully completes; and
transmit an indication to one or more of the UE, one or more other network devices, or a core network (CN) device, for completing the DL SDT.

2. The network device of claim 1, wherein the at least one processor is configured to cause the network device to determine that a connection with the UE is lost via at least one of:
a buffer corresponding to the SDT DL data is not empty;
a RRC message to complete the DL SDT has not been transmitted;
after predetermined times of failure of one or more of DL or uplink (UL) transmissions during the DL SDT within a serving cell;
after predetermined times of failure of one or more of DL or UL transmissions during the DL SDT within a serving cell if a reference signal received power (RSRP) of the UE is less than a threshold; or
expiration of a timer that starts or restarts upon the DL data transmission.

3. The network device of claim 1, wherein, the indication to the UE comprises at least one of:
an indication of a DL SDT or of a legacy DL data transmission on Uu interface for continuing previously transmitted DL SDT in which the DL data transmission has not successfully completed; or
one or more of a paging message or a legacy paging message for continuing previously transmitted DL SDT in which the DL data transmission has not successfully completed.

4. The network device of claim 3, wherein, the at least one processor is further configured to cause the network device to determine that the UE is in a trigger condition for autonomously triggering the paging message or legacy paging message.

5. The network device of claim 1, wherein, the indication to the one or more other network devices comprises at least one of:
a radio access network (RAN) paging message for continuing previously transmitted DL SDT in which the DL data transmission has not successfully completed; and
an indication to the one or more other network devices to initiate a mobile terminated (MT) SDT or a legacy data transmission to continue previously transmitted DL SDT in which the DL data transmission has not successfully completed.

6. The network device of claim 1, wherein, the indication to the CN device comprises at least one of:
an indication that the DL data transmission in the DL SDT has not successfully completed; and
an initiation of an access network (AN) release procedure to trigger a CN paging.

7. The network device of claim 1, wherein, the UE is identified by one or more of a stored radio network temporary identifier (RNTI) or an identity allocated by upper layers.

8. The network device of claim 1, wherein, the network device does not have a context of the UE, and the at least one processor is configured to cause the network device to transmit the indication to another network device that has the context of the UE.

9. A method performed by a network device, comprising:
transmitting downlink (DL) data during DL small data transmission (SDT) to a user equipment (UE) that supports a radio resource control (RRC) non-CONNECTED state;
determining that a connection with the UE is lost before the DL SDT successfully completes; and
transmitting an indication to the one or more of the UE, one or more other network devices, or a core network (CN) device, for completing the DL SDT.

10. The method of claim 9, wherein, the connection with the UE being lost is determined by at least one of:
a buffer corresponding to the SDT DL data is not empty;
a RRC message to complete the DL SDT has not been transmitted;
after predetermined times of failure of one or more of DL or uplink (UL) transmissions during the DL SDT within a serving cell;
after predetermined times of failure of one or more of DL or UL transmissions during the DL SDT within the serving cell if a reference signal received power (RSRP) of the UE is less than a threshold; or
expiration of a timer that starts or restarts upon the DL data transmission.

11. The method of claim 9, wherein, the indication to the UE comprises at least one of:
an indication of a DL SDT or of a legacy DL data transmission on Uu interface for continuing previously transmitted DL SDT in which the DL data transmission has not successfully completed; or
a paging message or a legacy paging message for continuing previously transmitted DL SDT in which the DL data transmission has not successfully completed.

12. The method of claim 11, further comprising: determining that the UE is in a trigger condition for autonomously triggering one or more of the paging message or the legacy paging message.

13. A user equipment (UE) for wireless communication, comprising:
at least one memory; and
at least one processor coupled with the at least one memory and configured to cause the UE to:
receive downlink (DL) data during DL small data transmission (SDT) from a network device;
reselect a neighboring cell when the DL SDT to the UE has not successfully completed; and
trigger a random access channel (RACH) in the reselected neighboring cell.

14. The UE of claim 13, wherein, the DL SDT comprises a mobile terminated (MT) SDT initiated by the network device.

15. The UE of claim 13, wherein the at least one processor is configured to cause the UE to store an identity in the at least one memory, and wherein, the stored identity is indicated in the RACH.

16. The UE of claim 13, wherein the at least one processor is configured to cause the UE to receive an indication for completing the DL SDT.

17. The UE of claim 16, wherein the indication comprises at least one of:
an indication of a DL SDT or of a legacy DL data transmission on Uu interface for continuing previously transmitted DL SDT in which the DL data transmission has not successfully completed; or
one or more of a paging message or a legacy paging message for continuing previously transmitted DL SDT in which the DL data transmission has not successfully completed.

18. A processor for wireless communication, comprising:
at least one controller coupled with at least one memory and configured to cause the processor to:
receive downlink (DL) data during DL small data transmission (SDT) from a network device;
reselect a neighboring cell when the DL SDT has not successfully completed; and
trigger a random access channel (RACH) in the reselected neighboring cell.

19. The processor of claim 18, wherein, the DL SDT comprises a mobile terminated (MT) SDT initiated by the network device.

20. The processor of claim 18, wherein the at least one controller is configured to cause the processor to store an identity in the at least one memory, and wherein, the stored identity is indicated in the RACH.
